(19) United States
(12) Patent Application Publication
(10) Pub. No.: US 2020/0196084 A1
(43) Pub. Date: Jun. 18, 2020

(54) LOCALIZED OUTPUTTING OF INFORMATION

(71) Applicant: ZF Friedrichshafen AG, Friedrichshafen (DE)

(72) Inventor: Nils MÜHL, Friedrichshafen (DE)

(21) Appl. No.: 16/630,128

(22) PCT Filed: Jun. 12, 2018
(86) PCT No.: PCT/EP2018/065491

§ 371 Date: Jan. 10, 2020

(30) Foreign Application Priority Data
Jul. 12, 2017 (DE) 10 2017 211 923.3

(51) Int. Cl. H04S 7/00; H04R 5/02; H04R 5/04; H04S 3/00

(52) U.S. Cl. CPC H04S 7/303; H04R 5/02; H04R 5/04; H04S 2420/01; H04R 2217/03; H04R 2499/13; H04S 3/002

(57) ABSTRACT

A method (200) for the selective notification of a person (110) on board a motor vehicle (105) including steps of receiving (205) a message; and activating a sound transducer (120) on board the motor vehicle (105) to emit sound waves (145). The sound waves (145) are amplitude-modulated by a modulation signal associated with the message. The sound transducer (120) is designed to emit ultrasound directed toward the person (110) to receive the notification, and a frequency of the modulation signal is within the audible range.

This application is a national stage completion of PCT/EP2018/065491 filed on Jun. 12, 2018 which claims priority from German Application Serial No. 10 2017 211 923.3 filed Jul. 12, 2017.

### FIELD OF THE INVENTION

The present invention relates to the outputting of information to a person onboard a motor vehicle. In particular, the invention relates to the outputting of information so far as possible only to a predetermined person.

### BACKGROUND OF THE INVENTION

On board a motor vehicle there may be several people, of whom one is the driver. Many events, which for example have been detected by a driving assistance system on board the motor vehicle, can be signaled to the driver acoustically. For example, a blind-spot assistance system can indicate whether another road user is located in the blind-spot of the motor vehicle. If so, an acoustic warning signal can be emitted.

U.S. Pat. No. 6,778,672 B2 relates to a system in which ultrasounds from various sources are superimposed in such manner that an audible frequency is produced at a predetermined position in a motor vehicle.

DE 11 2013 005 844 T5 proposes that in a motor vehicle having a right-hand and a left-hand speaker, information useful for the driver should only be issued by the speaker on the right.

DE 10 2004 015 671 A1 proposes a system for the subliminal emission of information to a person in a motor vehicle.

### SUMMARY OF THE INVENTION

While driving a large number of acoustic outputs can be directed at the driver. Most of these outputs are not of interest to the other people on board the motor vehicle and can be perceived as annoying. A purpose of the present invention is to indicate an improved technique for sending signals to a predetermined person on board a motor vehicle. The invention achieves that objective by virtue of the independent claims. Subordinate claims describe preferred embodiments.

According to a first aspect, a method for the selective notification of a person on board a motor vehicle comprises steps of detecting a message and activating a sound transducer on board the motor vehicle so as to emit sound waves, the sound waves being amplitude-modulated by a modulation signal associated with the message. The sound transducer is designed to send out ultrasound directed toward the person, and a frequency of the modulation signal is in the audible range.

The message can for example be a light that switches on when the vehicle is left, a spoken message, a signal tone as a warning of another road user located in a blind-spot, or may relate to an excessive speed or some other event or condition. In an embodiment the method can also be used as part of a hands-free device, for example for a mobile telephone. Moreover, a signal can be emitted when the motor vehicle is being partially or fully automatically controlled. The signal can relate to an isolated event or indicate a need to take over control of the motor vehicle. In general, the signal can be part of a cascade of warnings, which can be emitted with increasing urgency, for example to indicate an impending danger.

The sound waves in the ultrasound range can propogate along a predetermined direction in such manner that the scatter of the bundled sound waves can be very small. If the amplitude of the sound waves is sufficiently high, then in a non-linear medium such as air, demodulation within the sound beam can take place. A signal with the frequency of the modulation signal can then only be perceived by the human ear within the sound beam.

Accordingly, it is possible for certain acoustic information to be communicated exclusively to a predetermined person on board the motor vehicle; other persons on board the motor vehicle cannot hear the message. For example, whereas a driver can be informed acoustically about numerous events or conditions on board the motor vehicle, other people on board the motor vehicle are not bothered by corresponding acoustic signals. For example, the acoustic output of an entertainment or multi-media system can remain unchanged and despite that an acoustic message, perhaps in the form of a signal tone or a spoken word, can be reliably communicated to the driver.

It is particularly preferable for a plurality of sound transducers spaced apart from one another to be controlled so that each emits modulated sound waves, such that modulation signals from the sound transducers undergo a phase shift that indicates a position associated with the message. The sound transducers are preferably directed at different ears of the same person. In other words it is preferable, using the stereo effect, to communicate an acoustic signal to the person which can localize the person in relation to the signal direction. The person can therefore focus his attention directly in a direction in which he can pick up additional information about the message or react to the message.

For example, a parking aid can indicate to the driver not only a distance, but also the direction of an obstacle. Other direction-related outputs include for example an indication that a door of the motor vehicle is open, a dangerous situation outside the motor vehicle or a proposed turning maneuver of a navigation system. In addition, information can be supplied by a driver assistance system. In particular, an indication can be emitted about an object within the driver's field of view. For example, the object can be a pedestrian, cross-traffic, a cyclist or an obstacle in the road. The indication can also, for example, be directed at an information or traffic sign.

The information emitted can be received specifically on board or from outside the motor vehicle, for example by means of car-to-car (C2C) or car-to-infrastructure (C2I) communication.

In one embodiment the positions of the ears on the head of the person are determined and the phase shift of the modulation signals is determined as a function of a distance difference between the ears and the message and a distance difference between the ears and the sound transducers,

The modulation signals can have a phase shift that indicates the difference in distance between the ears and the position of the message. The difference in distance between the sound transducers and the ears can be taken into account in the determination of the phase shift. In that way a realistic stereo effect can be produced at the person, which allows him to localize the direction of the audible acoustic signal.

In an embodiment, the position of the person's head is determined and the sound transducer(s) is/are controlled in such manner as to direct their respective sound waves only toward the head. The position of the head can be determined, for example, on the basis of an adjustment position of the seat on which the person is sitting. Alternatively, the position of the head can also be determined actively, on the basis of scanning signals from a device scanning the inside space of the motor vehicle. In a refinement, the position of the person's ears and head can also be determined and the sound transducers are controlled so that they each emit their sound signals only to one of the ears.

It is also preferable to assign different modulation sequences to different predetermined messages. A predetermined modulation sequence can in particular include the signal pattern of an audible tone, a noise or a spoken text.

According to a second aspect, a device comprises an interface for the reception of an indication about a message; a sound transducer, which is designed for the emission of sound waves; a modulation generator designed to produce a modulation signal for the sound transducer; wherein the sound transducer is designed to modulate the amplitude of the sound waves it emits as a function of the modulation signal. In this case the sound transducer is designed to send out ultrasound directed at the person and a frequency of the modulation signal is in the audible range.

The device can in particular be designed to carry out the method described above. In an embodiment, the device is controlled by means of a processing device that comprises a programmable microcomputer or microcontroller. The method may then take the form of a computer program product. Program code means of the computer program product can be run on the processing device, or can be stored on a computer-readable data carrier. Features or advantages of the device can be related to the method, and vice-versa.

Preferably a plurality of sound transducers are provided, and the modulation generator is then designed to produce modulation signals for the sound transducers with a phase shift that indicates a position of the message. The sound transducers are preferably located in various directions relative to the person. In an embodiment, the person can be selected on the basis of his position inside the motor vehicle. The motor vehicle can have room for more people than can be informed by means of the device. For example, the notification can be provided only for a driver of the motor vehicle, who can be positioned only at a predetermined point in the motor vehicle, for example at the front left.

In an embodiment, one of the sound transducers is directed mechanically at a target. In another embodiment one of the sound transducers comprises a plurality of sound-producing elements and the direction of the radiated sound waves depends on a phase difference of the control signals of the elements. Such an arrangement is also known as a phased array. The direction in which a sound beam is sent out by the sound transducer can then be changed without having to move the sound transducer mechanically. The sound-producing elements can for example comprise piezo-elements. The piezo-elements can be arranged next to one another on a flat surface.

The device can comprise a scanning device for determining a position of the person's head. The scanning device can comprise, for example, an interior camera, a pyrometer for locating the person by virtue of his natural infrared heat radiation, or some other appropriate means. In one embodiment, the position of the head can also be determined by some other means, for example an accident avoidance system or a system for minimizing the consequences of an accident. In this case an interface can be provided instead of the scanning device.

One of the sound transducers can be designed to direct the sound waves towards the person by reflection off a window of the motor vehicle. For this indirect sound exposure the mechanical orientation of the sound transducer is preferred. The window can in particular be a front- or windshield pane of the motor vehicle. In that way the acoustic directional resolution in the direction of travel can be improved without providing sound sources on each side of the front window.

In still another embodiment a plurality of sound transducers are arranged along a predetermined curve in the motor vehicle. The curve preferably extends parallel to a subsurface of the motor vehicle and can for example have a parabolic shape. In this way the focusing of audible sound in the area of the person or his head can be improved. The sound transducers can be located at various points in the motor vehicle, for example in the roof of the vehicle, on the dashboard or in a column of the vehicle,

### BRIEF DESCRIPTION OF THE DRAWINGS

The invention will now be described hi greater detail with reference to the attached figures, which show:

FIG. 1:An embodiment of a device on board a motor vehicle;

FIG. 2: A sequence diagram for an example of a method for signaling to a person on board a motor vehicle; and

FIG. 3a, 3b, 3c: Examples of arrangements of sound transducers on board a motor vehicle.

### DETAILED DESCRIPTION OF THE PREFERRED EMBODIMENTS

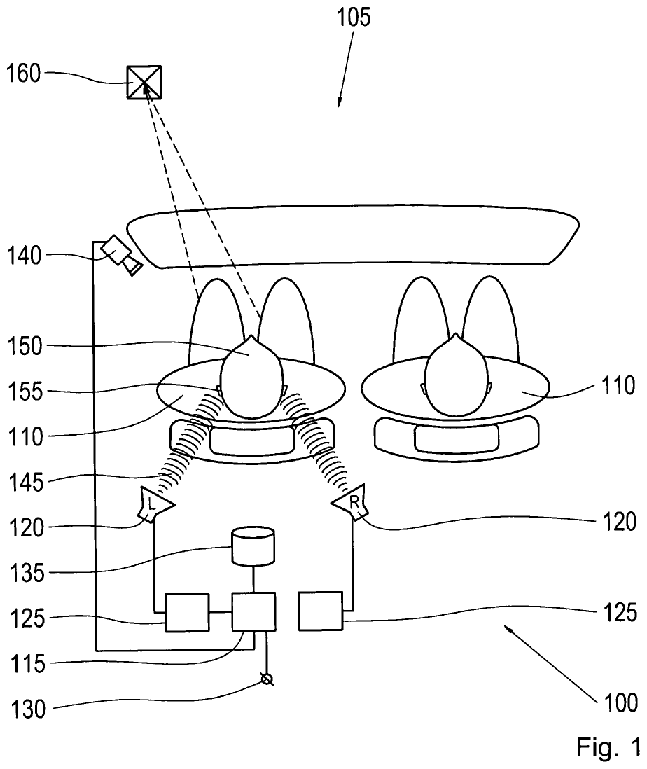

FIG. 1 shows a device 100 on board a motor vehicle 105. The motor vehicle 105 is preferably designed to carry several people 110. One of the people 110 can be a driver, who is controlling the motor vehicle 105 or is ready to take control of the motor vehicle 105. The device 100 is designed to provide one of the people 110—in particular the driver—with acoustic information without thereby bothering other people 110 on board the motor vehicle 105.

The device 100 preferably comprises a processing device 115, one or more sound transducers 120 and preferably a respective modulator 125 for each sound transducer 120. Optionally, an interface 130 or a memory device 135 can be provided. Furthermore a scanning device 140 can be provided for scanning an interior of the motor vehicle 105.

The sound transducers 120 are in each case designed to emit sound waves in the inaudible ultrasound range in a directed manner. The fundamental frequency of the sound waves emitted can for example be in the range of around 65 kHz. The wavelength of the sound waves is then so small that in air they travel almost without, or only with very little spreading out. Each sound transducer 120 sends out a directed sound beam 145, which is targeted at a predetermined person 110, preferably to his head 150 and even more preferably to one of his ears 155. Different sound transducers 120 can be assigned to different ears 155. The positions of the sound transducers 120 preferably differ from one another in order to create as good as possible a stereo basis.

The sound waves emitted by the sound transducers 120 preferably have large amplitudes, which enable sound pressures for example in the range of around 100 dB in the sound beam 145. With so great a power of the sound waves emitted, the speed of sound in air, with which the sound beam 145 extends, can change so that the air behaves in a non-linear manner and acts as a demodulator. A modulation signal which would modulate the ultrasonic signal by one of the modulators 125, thereby becomes audible within the sound beam 145. Outside the sound beam 145, in contrast, the modulation signal cannot be perceived by a human ear.

Thus, the device 100 can communicate perceptible acoustic messages for a predetermined person 110 on board the motor vehicle 105. In the embodiment described the modulation signal is preferably generated by the processing device 115. For this, a message or notification of a message can be received via the interface 130 and a modulation sequence associated with the message can be recovered from the memory device 135. Alternatively, the modulation sequence can also be received together with the message via the interface 130. In particular the modulation sequence can comprise a tone, a sound or a spoken text. The modulation sequence can be used directly as a modulation signal, if only one sound transducer 120 is provided or if more than one sound transducer 120 are to be modulated by means of the same modulation signal.

In a preferred embodiment, the information to be conveyed acoustically to the person 110 should in addition comprise a direction. The direction should be coded acoustically, in that the perceptible sound produced by the sound transducer 120 in the area of the person 110 appears to the person 110 to be coming from the corresponding direction. In particular the sound can be related to a predetermined position 160, which can in particular be ahead of the person 110 or ahead of the motor vehicle 105. To make the direction of the sound acoustically experiential, the sound transducer 120 can emit phase-shifted sound information in the manner of a stereo unit, In that case the phase shift preferably relates only to the modulation signal, which mainly results in an acoustically perceptible effect.

In the embodiment shown, as an example a distance between a first sound transducer 120 and the left ear 155 of the person 110 is the same as the distance between a second sound transducer 120 and the right ear 155 of the person 110. To code the position 160 acoustically, the phase shift of the modulation signal should be the same size as the difference of the distances between the position 160 and the two ears 155, converted with reference to the spreading rate of audible sound in air. If the distances between the sound transducers 120 and the respectively associated ears 155 of the person 110 are different, then the phase shift can be corrected with reference to that difference.

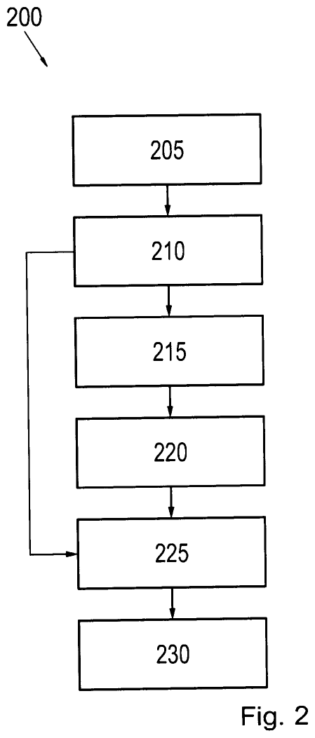

FIG. 2 shows a sequence diagram of an exemplary method 200 for signaling to a person 110 on board the motor vehicle 105. In particular the method 200 can be carried out by means of the device 100 in FIG. 1. For that purpose the method 200 can be controlled by the processing device 115. The method 200 illustrated relates to the direction-sensitive provision of acoustic information to a predetermined person 110. The simpler variant of an information output associated with a message or position can be derived easily by omitting all the steps that amount to the determination of the phase shift.

In a first step 205, an event and a position 160 are detected. The event is preferably detected via the interface 130 and the position 160 can be associated firmly with the event or likewise received via the interface 130. In a step 210, the position of the head 150 of the person 110 can be determined. The determination can be carded out in particular on the basis of scanning values generated by the scanning device 140. In a refinement of the method 200 the positions of the ears 155 on the head 150 of the person 110 can also be determined. In a step 215, preferably the position 160 of the event relative to the head 150 is determined. This relative position can be expressed as a combination of the direction and the distance of the position 160 from the head 150.

In a step 220, a phase shift of an acoustic signal appropriate for the direction identified is determined. Preferably, the phase shift is determined in relation to a travel time difference of the audible sound in air between the position 160 and the positions of the ears 155. In an embodiment, distances between the sound transducers 120 and the ears 155 are additionally taken into account, so that these have no influence on a travel time difference of an audible signal at each respective ear 155. The remaining travel time difference of the acoustically perceptible signal can then be reinterpreted directly and intuitively by the person 110 into a direction toward the position 160 or at the position 160.

In a step 225, in particular on the basis of the positions determined in step 210, further phase shifts can be determined, whose individual sound-producing elements are subject to a sound transducer 120, in order to control the emission direction of the sound beam 145. These phase shifts are preferably chosen such that the sound beam 145 from a sound transducer 120 is associated with just one ear 155 of the person 110. It is assumed that a sufficient number of sound transducers 120 are present on board the motor vehicle 105 for at least one sound transducer 120 to be assigned to each ear 155.

In a step 230, the sound transducers 120 are activated so as to emit modulated, directed ultrasonic waves. The modulation takes place mainly by means of a modulation signal or a modulation sequence that corresponds to an audible tone or sound. The modulation signals are preferably the same for all the sound transducers 120, but can be phase-shifted between the sound transducers 120 in order to give the person 110 the impression that the tone or sound comes from the position 160.

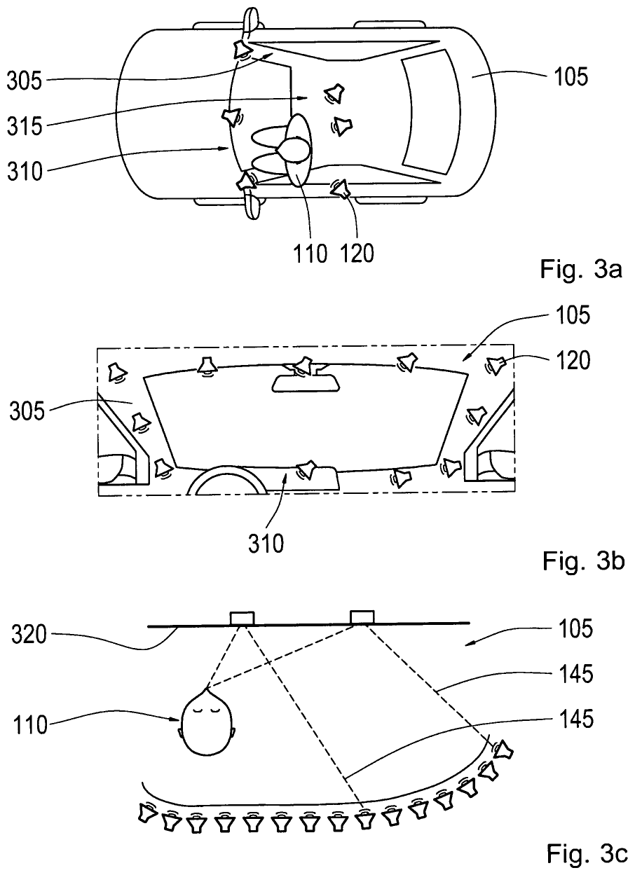

FIGS. 3a, 3b and 3c show example arrangements of sound transducers 120 on board a motor vehicle 105.

FIG. 3a shows a schematic view of the motor vehicle 106 as seen from above. Sound transducers 120 can for example be fitted in the area of an A-column 305, a dashboard 310 or a vehicle roof 315. In the transverse direction sound transducers 120 can be arranged on the left, in the middle or on the right of the motor vehicle 105 or of the person 110 to be addressed. Other positions are also possible.

FIG. 3b shows a view inside the motor vehicle 105 through a front windshield 320 of the motor vehicle 105. Sound transducers 120 can be arranged at various positions around the windscreen 320. Possible positions include the dashboard 310, the left-hand or right-hand A-pillar 305 and the vehicle roof 315.

FIG. 3c shows a schematic view from above, of a further example arrangement of sound transducers 120 on board the motor vehicle 105. In this example two of the sound transducers 120 are designed to direct their sound beams 145 at the driver 110 in each case not directly but by reflection in the front windscreen 320. This increases the spreading path between the sound transducer 120 and the person 110, as shown. In that way a better acoustic effect of a position 160 in front of the windscreen 320 can be produced.

A plurality of sound transducers 120 can also be arranged along a predetermined curve 325. The curve 325 can extend essentially around the person 110. In a preferred embodiment the curve is of parabolic shape, at least in parts.

In general, each sound transducer 120 can comprise one or more sound-producing elements. In an embodiment, a large number of sound transducers 120, each with only one sound-producing element can be provided, the sound transducers 120 being distributed over a larger area inside the motor vehicle 105, as for example along the curve 325.

### INDEXES

100 Device
105 Motor vehicle
110 Person
115 Processing device
120 Sound transducer
125 Modulator
130 Interface
135 Memory device
140 Scanning device
145 Sound beam
150 Head (position)
155 Ear (position)
160 Position
200 Method
205 Detection of event and position
210 Determination of the position of the person's head
215 Determination of the position of the event relative to the head
220 Determination of a phase shift of the modulation signal relative to the distances between the ears and the event, and between the ears and the sound transducers
225 Determination of phase shifts for controlling the emission direction
230 Activation of the sound transducers to emit modulated, directed ultrasonic waves
305 A-pillar
310 Dashboard
315 Vehicle roof
320 Front windscreen
325 Curve

1-11. (canceled)

12. A method (200) for selective notification of a person (110) on board a motor vehicle (105), the method (200) comprising:
detecting a message;
activating a sound transducer (120) on board the motor vehicle (105) to emit sound waves (145);
amplitude-modulating the sound waves (145) by a modulator signal associated with the message; and
the sound transducer (120) being designed to emit ultrasound directed toward the person (110) and a frequency of the modulation signal is within the audible range,

13. The method (200) according to claim 12, further comprising activating a plurality of sound transducers (120), which are spaced apart from one another so that each one of the sound transducers emits modulated sound waves (145), and the modulation signals of the sound transducers (120) have a phase shift that indicates a position (160) associated with the message.

14. The method (200) according to claim 13, further comprising determining positions of ears (155) on a head (150) of the person (110), and determining the phase shift of the modulation signals as a function of a distance difference between ears (155) of the person and the message and a distance difference between the ears (155) of the person and the sound transducers (120).

15. The method (200) according to claim 12, further comprising determining a position of a head (150) of the person (110), and the sound transducer (120) is activated so as to direct the sound waves (145) only toward the head (150).

16. The method (200) according to claim 12, further comprising associating different modulation sequences with different predetermined messages.

17. A device (100) for selective notification of a person (110) on board a motor vehicle (105), the device comprising:
an interface (130) for receiving an indication about a message;
at least one sound transducer (120) designed to emit sound waves (145);
a modulation generator (115) designed to produce a modulation signal for the sound transducer (120), the sound transducer (120) is designed to modulate an amplitude of the sound waves (145), emitted by the sound transducer (120), as a function of the modulation signal; and
the sound transducer (120) being designed to emit ultrasound directed toward the person (110) and a frequency of the modulation signal is within the audible range.

18. The device (100) according to claim 17, wherein a plurality of sound transducers (120) are provided; and the modulation generator (115) is designed to produce modulation signals for the sound transducers (120) with a phase shift that indicates a position (160) of the message.

19. The device (100) according to claim 17, wherein the at least one sound transducer (120) comprises a plurality of sound-producing elements, and a direction of the sound waves (145) emitted depends on a phase difference of control signals of the sound-producing elements.

20. The device (100) according to claim 17, further comprising a scanning device (140) for determining a position of a head (150) of the person (110).

21. The device (100) according to any of claim 17, wherein the sound transducer (120) is designed to direct the sound waves (145) toward the person (110) by reflection in a windowpane (320) of the motor vehicle (105).

22. The device (100) according to claim 17, wherein a plurality of sound transducers (120) are arranged along a parabolic curve (325) in the motor vehicle (105).

23. A method of notifying only a selected person within a motor vehicle of a message, the method comprising:
detecting a message;
activating a sound transducer within the motor vehicle to emit ultrasound sound waves, and modulating an amplitude of the ultrasound sound waves by a modulation signal associated with the message, and the modulation signal having a frequency within an audible range; and
directing, with the sound transducer, the ultrasound sound waves toward the selected person to be notified.

24. The method according to claim 23, further comprising:
detecting the message with an interface, and the message is an event and the event is associated with an event position;
determining, with a processing device, a position of the selected person within the motor vehicle;
determining a distance between the position of the selected person and the event position and a relative direction from the position of the selected person to the event position;
producing the modulation signals with a modulation generator based on the determined distance between the position of the selected person and the position of the event and the relative direction from the position of the selected person to the event position;
modulating the ultrasound sound waves of the sound transducers with the modulation signals having a phase shift that corresponds to the event position to notify the selected person of the event and the event position; and
directing the modulated ultrasound sound waves toward the selected person to notify the selected person of the event and the event position.
